(19) United States
(12) Patent Application Publication
(10) Pub. No.: US 2014/0164075 A1
(43) Pub. Date: Jun. 12, 2014

(54) Sports Voting System

(71) Applicant: David John TRUJILLO, Temecula, CA (US)

(72) Inventor: David John TRUJILLO, Temecula, CA (US)

(21) Appl. No.: 14/100,015

(22) Filed: Dec. 9, 2013

Related U.S. Application Data
(60) Provisional application No. 61/734,974, filed on Dec. 8, 2012.

(51) Int. Cl. G07C 13/00

(52) U.S. Cl. CPC G07C 13/00
USPC 705/12

(57) ABSTRACT

The present disclosure relates to an internet based system for individuals that want to be able to voice their opinion about all aspects of a judged event in the form of a vote and/or score for who should have won and other aspects of the event. The votes have no bearing on the outcome of the judged event. However votes counts are tabulated by the present invention and made available to members and are optionally available to the public and for media syndication. Income is generated by charging members fee and making sponsorships available to other businesses.

### CROSS-REFERENCE TO RELATED APPLICATIONS

This application claims the benefit of U.S. Provisional Application No. 61/734,974 entitled “Sport Voting System” filed on 8, Dec. 2012, the entire disclosure of which, is fully incorporated herein by reference for all purposes.

### FIELD OF THE INVENTION

This present invention relates to a system for obtaining a popular vote from fans and spectators of any sporting event who have become members of the system. More specifically, the present invention relates to a system for allowing the members to provide an opinion vote before, during and after a boxing, mixed martial arts event and many other events without affecting the official results of the event.

### BACKGROUND OF THE INVENTION

Sporting events have been personally observed by spectators since the days of the Roman Empire and probably before. Today with radio, television, smart phones, tablets and other such equipment, the observation of sporting events does not require one to be present to watch and observe a sporting event. Sporting events include not only the main sports such as baseball, football, soccer, basketball, hockey, car races, horse races and golf but also include, without limitation, numerous other events such as boxing, mixed martial arts, skiing and snowboarding, boat racing, tennis, racquetball, motorcycle racing, rugby, cycling, swimming, cricket, and bowling.

The internet is becoming available to a large percentage of the U.S. and global populations and individuals not only use their personal computers to access the internet, but smart cell phones and tablets having wireless capability also allow individual to connect to the internet. Also, with the advent of smart cell phones, the availability of special applications, commonly known as “Apps” has proliferated, thus providing cell phone owners with a wide variety of expanded uses of their mobile devices.

The observance of a sporting event can be in-person or remotely, via broadcast television, cable, or internet streaming video both in real time or rebroadcast after the actual event. As used herein, event or sporting event refers to a type of competition or performance in which the performance is evaluated, judged or scored and/or winners are decided.

In many sporting events that are judged by one or more umpires, judges, referees, linesmen, or other officials (herein after referred to as “officials”), there may be a number of spectators that disagree with the judgment call. With many events being digitally recorded, the review of plays in football games is now possible. In other events, such as in boxing, the judging system is sometimes viewed with some suspicion. Boxing judging suffers probably not from intentional or questionable logic but rather more from qualitative variables in the event. There exists an unmet need for a method and a system that is capable of tabulating the voting and/or scoring of the general public in regards to the official judgment of various aspects of events.

### BRIEF SUMMARY OF THE INVENTION

The present disclosure relates to a web based Sport Voting System (“System”) and method that enables members to register their opinion via about a judged event in the form of a vote and/or score for who should have won an event and other aspects of that event. Through various administrative and computer means, it is possible, to a large extent, to limit each person to a single vote for each event. This is accomplished by requiring a person to become a member by providing identifying information and paying for the right to vote. The votes have no bearing on the outcome of the judged event. The System would have no affiliation or relationship with the official sanctioning organization that oversee the event and the tabulation of the voting and/or scoring of the members would not be officially linked to the calls on the various aspects of the event or the final winner. As used herein, voting and scoring are used more or less interchangeably with voting generally referring to a yes/no situation such as the hit was or was not a foul ball, pitch was or was not a strike, and similar aspects of an event. Scoring would generally be used in situations where a numeric evaluation of performance would be required such as in the case of a gymnastic routine or a performance of a boxer during a specific round.

However. voting and scoring are tabulated by the present invention system and are available to the members, users and optionally available for media syndication. As used herein, tabulate means to gather together all of the votes submitted by the members and present the data back to the members on their monitoring devices. Tabulation can include, but not be limited to categorizing the votes by age, sex, geographical region, team affiliation and any other factors known by the System about the members. In addition to allowing voting by members on the overall outcome of an event, the System also allows for voting on various aspects of the event. These various aspects can include individual judgment calls by an official during an event such an offsides call, incomplete pass in football, balls and strikes in baseball, winner of a boxing match, winner of a 100-yard dash, shot clock violation in basketball, scoring for a gymnastic performance and similar subjective judgments by officials in any event.

Votes are submitted by the members via an electronic monitoring apparatus which runs the monitor software. When votes are submitted, some monitoring apparatuses may submit additional data, including the geographical location as well as information about the apparatus, such as brand, model and connection type.

The System servers run server software which enables communication with the monitoring apparatuses via the internet or other communication means, store the event databases, receive and tabulate the incoming votes from member's monitoring devices, handle all needed operations to perform the requirements of the System and allow System staff to update event information, update contested plays, and perform system maintenance. The System staff regularly enters information about scheduled judged events into the System database system via an online control panel which is part of the server software. That data includes names and photos of the contenders in the event, the date, time and venue of the event, the channel the event will be broadcast on or the website the video recording of the event can found. System staff will also monitor in real time each of the events and adjust the System databases in response to the actual event. For example, a boxing match that was scheduled for ten rounds may terminate early if there is a knock-out. In that case the System will adjust the number of rounds of the boxing match and limit voting to only the number of rounds actually fought.

The general public can become non-voting users by providing a system ID name, an e-mail address and a password. Users are able to browse upcoming and recent events on the System via their chosen monitoring apparatus. In addition users are able to view the voting results of the members.

Members are able to browse the events just as users are. Members can also engage in “Smack Talk” which is commenting on a specific event. Smack Talk also does not affect the outcome of the event, but is an outlet for members to engage with each other in text based discussion.

Events listed on the System may display a countdown clock to the start of the event. Once the event time is reached, the clock changes to display “In Progress” or “Starting Shortly”. Once the event is over, the System staff uses the online control panel to change the status of the event to completed. Once an event is completed, members are able to place a vote on the contender they felt should have won, regardless of who was officially chosen as the winner. In addition, members can vote on judgment calls made by officials that occur during the game. Voting and scoring can also be entered for a predetermined period of time, typically 24 hours, after the end of the event.

When a user or member makes a request of the System service, their monitoring apparatus connects to an available wireless or wired communication connection. That travels through the service provider to the internet and then to the System Server. The System Server then processes the request, queries the database and then passes back to the monitoring apparatus via the same pathway the request came in through, but in the opposite direction. The monitoring apparatus processes the response and displays it on the screen.

### BRIEF DESCRIPTION OF THE DRAWINGS

FIG. 1 shows a Monitoring Apparatus displaying the Login screen;

FIG. 2 shows a Monitoring Apparatus displaying the List of Events screen;

FIG. 3 shows a Monitoring Apparatus displaying the various scoring methods that can be selected by the member;

FIG. 4 shows a Monitoring Apparatus displaying the details of the event selected by the member prior to the start of the event;

FIG. 5 shows a Monitoring Apparatus displaying the details of the event when the member has selected the Round-by-Round scoring method;

FIG. 6 shows a Monitoring Apparatus displaying the details of the event when the member has selected the Judge Like the Pros scoring method;

FIG. 7 shows a Monitoring Apparatus displaying the Ring Card Girl screen;

FIG. 8 shows a Monitoring Apparatus displaying the Comment Entry screen;

FIG. 9 shows a Monitoring Apparatus displaying the details of the after-the-event screen associated with the Easy One-tap scoring method;

FIG. 10 shows a Monitoring Apparatus displaying the after-the-event Ring Card Girl voting screen;

FIG. 11 shows a Monitoring Apparatus displaying the details of the after-the-event screen associated with either Round-by-Round or Blow-by-Blow scoring method; and

FIG. 12 shows a graphic representation of the various components of that make up the System.

### DETAILED DESCRIPTION OF THE PREFERRED INVENTION

The following description discloses the invention which has been configured to work with boxing matches as the event. It is within the scope and spirit of the invention that the invention can be configured to work with other two-contender sports such as tennis and wrestling. In addition the invention can be configured to work with sports involving two teams such as baseball, football, basketball and soccer. In such cases the scoring methods will be configured for the particular sport as described below.

This embodiment is based upon the use of a mobile device such as a smart phone or a tablet as the monitoring apparatus. With theses devices, selection is typically made by use a touch screen and then tapping the screen with a finger or a stylus. However, the System can be used with a lap top or desktop computer and selection is more typically made with a mouse, though there are laptops and desktops with touch screen monitors. It is to be understood that references to click, clicking, clickable, select, selecting, selectable or similar terms all refer to any known means of designating or activating a particular option that has been displayed on the Mobile Device 7 or on a monitoring apparatus generally.

The following description makes reference only to members. Users can access the same System except that they would not be permitted to vote on any aspect of the events. The following description is directed to a boxing event. The System can be configured to handle any number of other events.

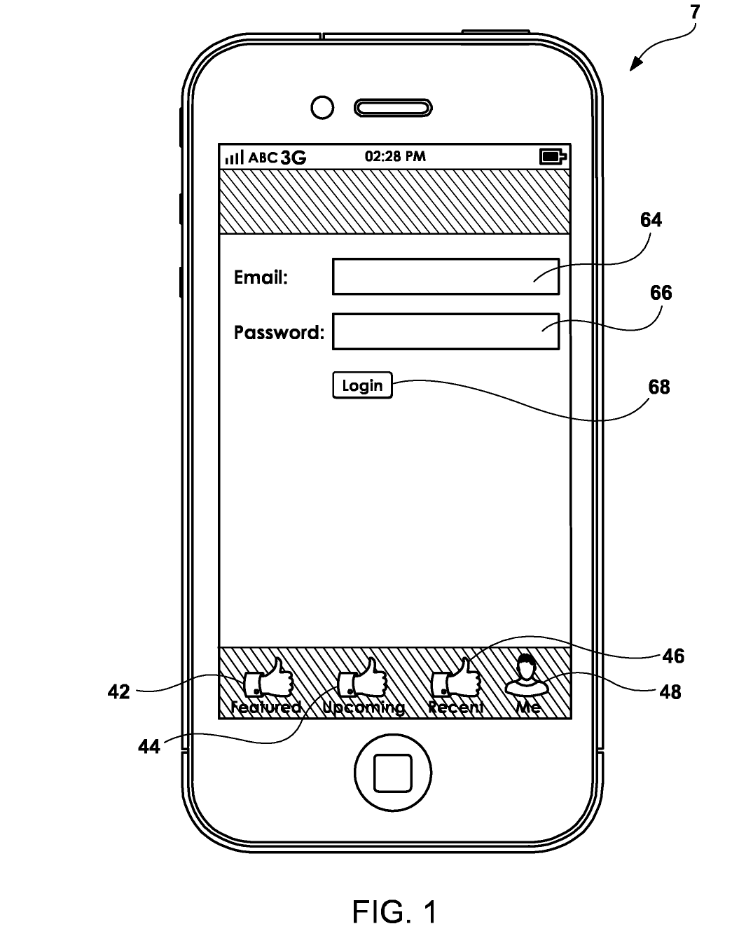

FIG. 1 shows a perspective view of a Monitoring Device 7, which would include but not be limited to a cell phone, smart phone, tablet, or computer, which shows the Login screen. There is an e-mail Login Input Field 64 for entry of the member's login e-mail address. Also displayed is a Password Input Field 66, for entry of the member's login password. Once the login e-mail address and the password have been entered, the member clicks on the Login button 68 to effectuate login.

A critical aspect of the System is to limit, as much as reasonably possible, each member to a single vote for each event or portion of an event in which voting is enabled. The System will allow only one member per e-mail address. In order to have voting privileges a member must pay the required fee either in advance or at the time of voting. Thus another means of limiting each member to a single vote is to allow only a single member registration per credit card or other payment means. Thus any single credit card number can be used to register only a single member. The limitation of one member per e-mail address and one member per credit card number would go a long way to minimizing multiple votes by the same person.

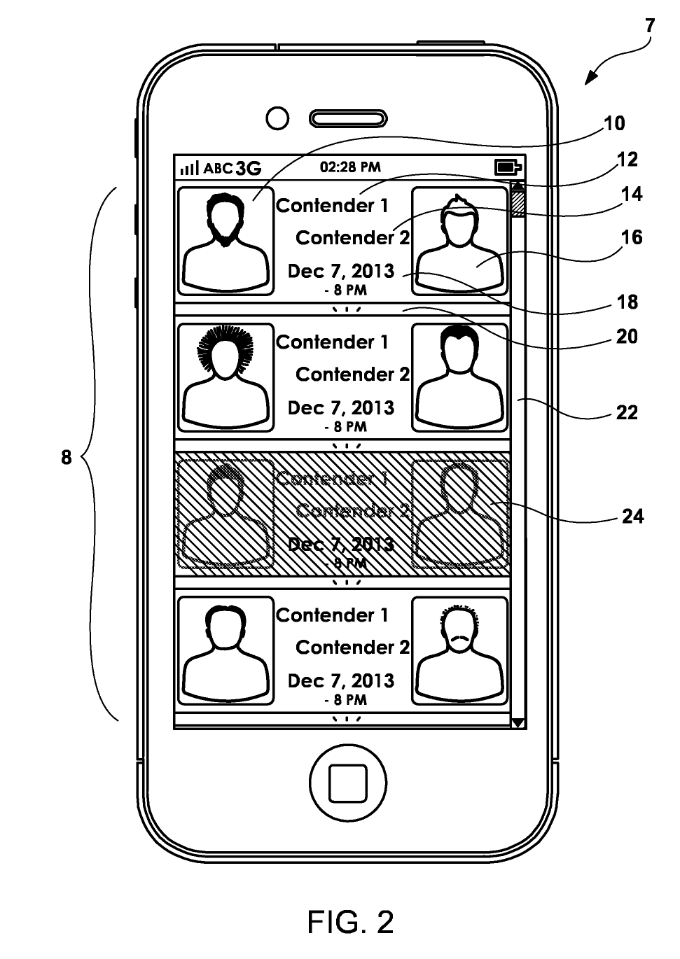

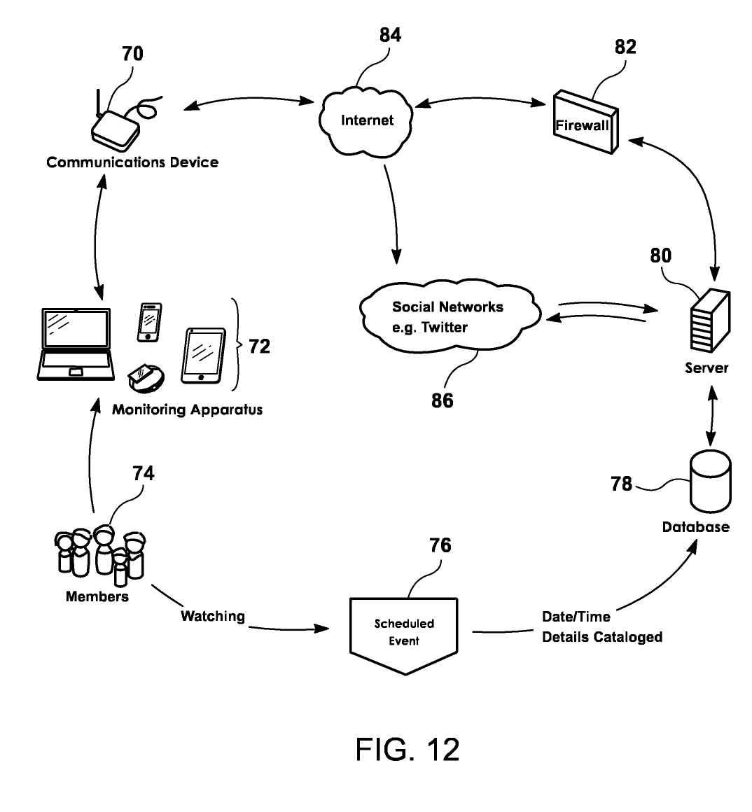

Once the user has been properly logged in, FIG. 2 is displayed. FIG. 2 show a list of events as stored by the System Server 80 (FIG. 12) and allows the member to scroll through the list, select one event and view details of that event. The Monitoring Device 7 displays a List of Events 8 along with a summary of details about the event. The details include the Name of First Contender 12, a Photo of First Contender 10, the Name of the Second Contender 14, and a Photo of the Second Contender 16. This example is typically for two-contender sporting events such as boxing and tennis Other screen configurations will be necessary for team sports that include numerous contenders, such as soccer, football and basketball.

Each event has a Clickable Area 24, which when clicked, will cause the system to move to the next screen. Scroll Bar 22 allows the member to scroll the List of Events 8 to display the Clickable Area 24 of the event which the member wants to view. Other configurations can be utilized, such as placing the scroll bar on the left side of the screen, or scrolling the List of Events 8 horizontally.

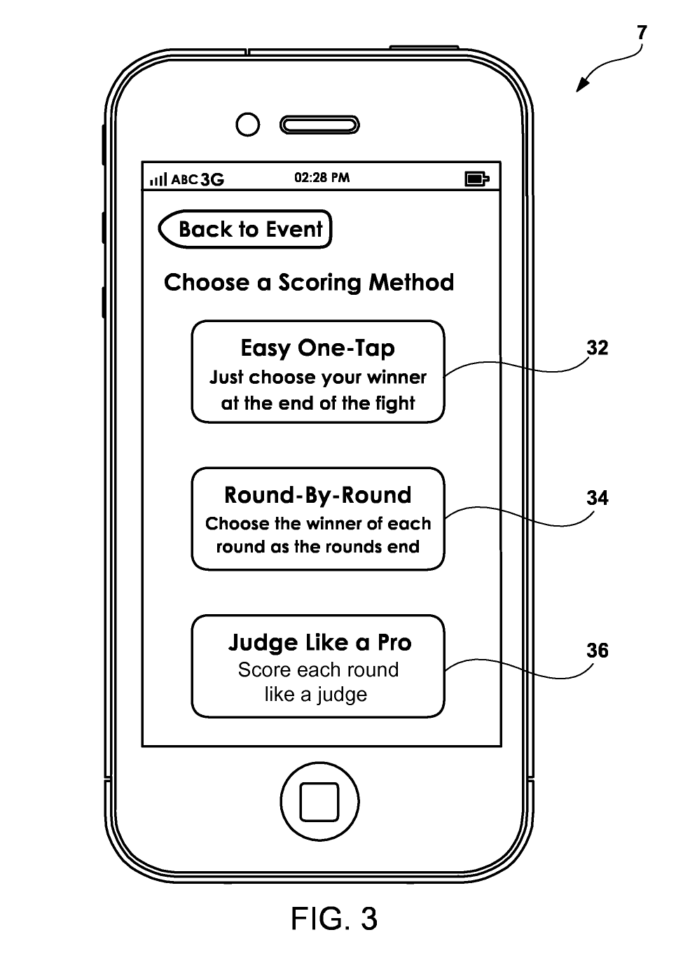

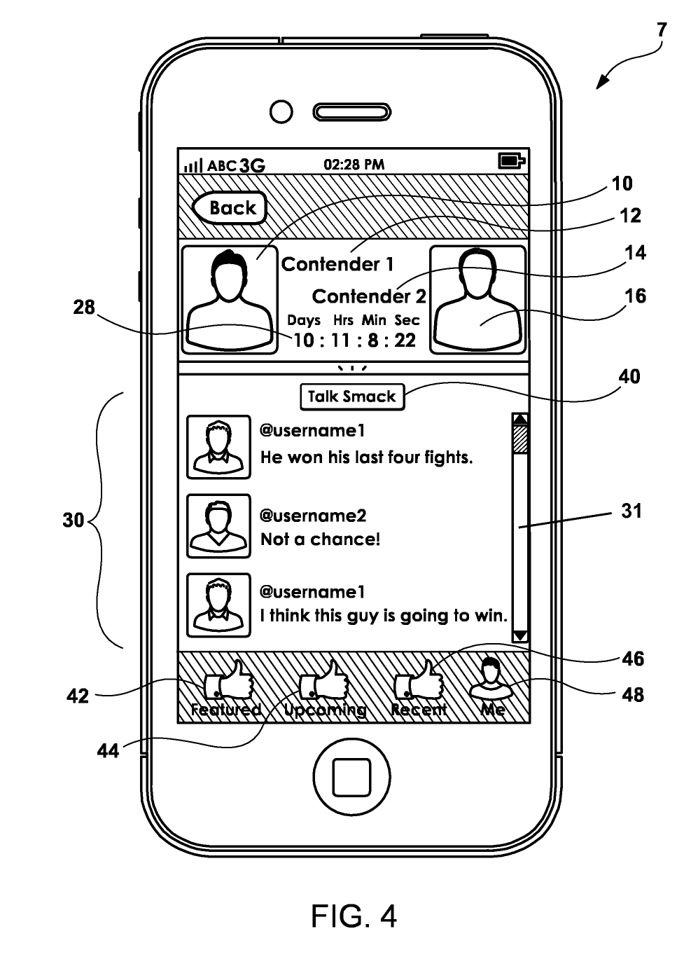

If the member clicks on a the Clickable Area 24 for an event, the member is then presented with the Choose a Scoring Method screen as shown in FIG. 3 if the event has started. If the event has not started the member is taken to the Count Down Screen as shown in FIG. 4.

FIG. 4 is only displayed prior to the start of the selected event. A Photo 10 of Contender 1, the Name 12 of Contender 1, the Name 14 of Contender 2 and a Photo 16 of Contender 2 are shown. A countdown timer 28 is shown which displays the time remaining before the start of the event. Shown below the contender information is a scrollable List of Comments 30. This List can be scrolled with the Scroll Bar 31. In this embodiment, the newest comments by members appear at the top with previous comments listed in sequence below. The comments displayed may include a photo of the member and the member's e-mail and/or twitter handle. Also included on the screen is Back Button 26 that moves the member to the previous screen. Displayed along the bottom of the Monitoring Device 7 are four buttons. A Feature Button 42 will take the member to a Feature Events List screen. There is also an Upcoming Button 44 which takes the member to an Upcoming Events List screen. Also included is a Recent Button 46 which takes the member to a Recent Events List screen. Finally there is Me Button 48 which takes the user to the login screen as shown in FIG. 1. These same four buttons are displayed on a number of other screens displayed by the System. Once the Coundown Timer 28 nears the start of the match, the member is taken to the Chose a Scoring Method screen as shown in FIG. 3.

If the member is taken to Choose a Scoring Method, then the member will see the screen shown in FIG. 3. For the event of boxing, there are three scoring methods. The Easy One-Tap method can be selected by clicking on Easy One-Tap Button 32. This scoring method allows the member to select an overall-winner at the end of the fight.

The Round-by-Round method can be selected by clicking on Round-by-Round Button 34. This method allows the member to select one contender as the winner of each round. The System will automatically cast a vote for one of the contenders as the winner, based upon the member's overall scoring of the match.

The Judge Like a Pro method can be selected by clicking on the Judge Like a Pro Button 36. This will allow the member to score the fight in same manner as professional judges.

Once the user has clicked on one of the scoring methods and the event has started, the member is presented with a new screen based upon the particular scoring method chosen.

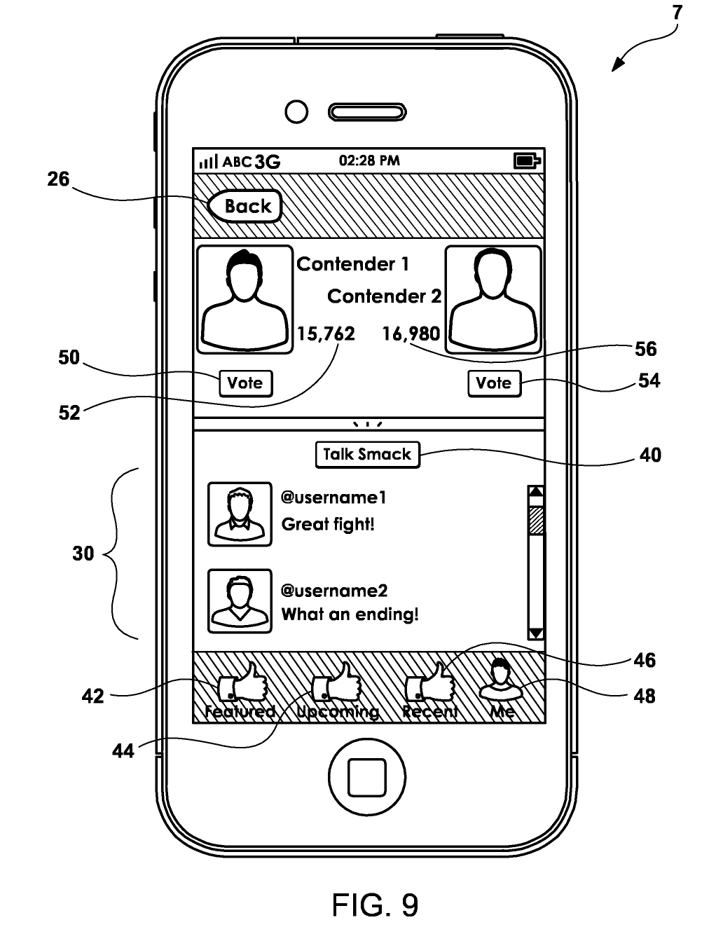

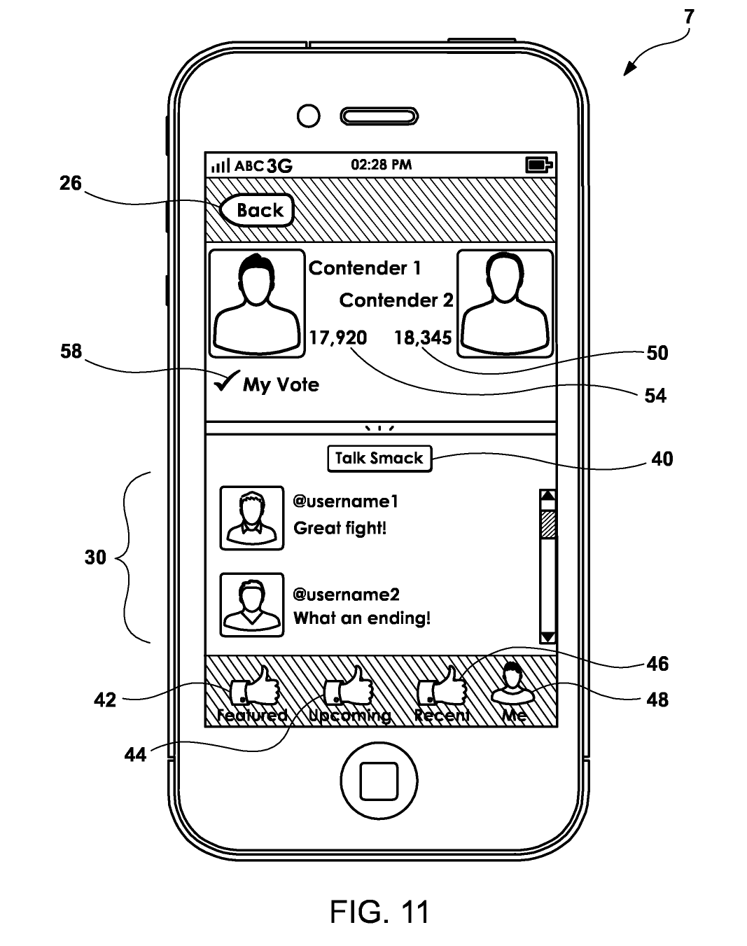

If the member chose the Easy One-Tap scoring method then the screen shown in FIG. 9 is displayed. This allows the member to vote for one of the contenders after the match has terminated. The scores that have already been cast are shown in Tally 50 for Contender 1 and Tally 54 for Contender 2. Each member can cast their single vote any time during a pre-defined period of time, typically up to 24 hours after the match is over. This is accomplished by clicking on Vote Button 52 or Vote Button 56. Once the member has voted, the System will display the Final Score screen shown in FIG. 11.

The Final Vote screen shown in FIG. 11 shows the names and photos of Contenders 1 and 2. In addition, the My Vote Icon 58 is shown below the contender that the member has selected as the winner. As previously shown in FIG. 9, the current votes for each contender are shown in Tally 50 and Tally 54. These Tallies are updated in real time until the close of the allowed voting period. Also present is the List of Comments 30 and the buttons previously described along the bottom of the screen: Featured 42, Upcoming 44, Recent 46 and Me 48. If the event supports the entry of Contested Plays, then a button to take the member of the Contested Plays screen to see the tabulations of votes regarding the entered Contested Plays.

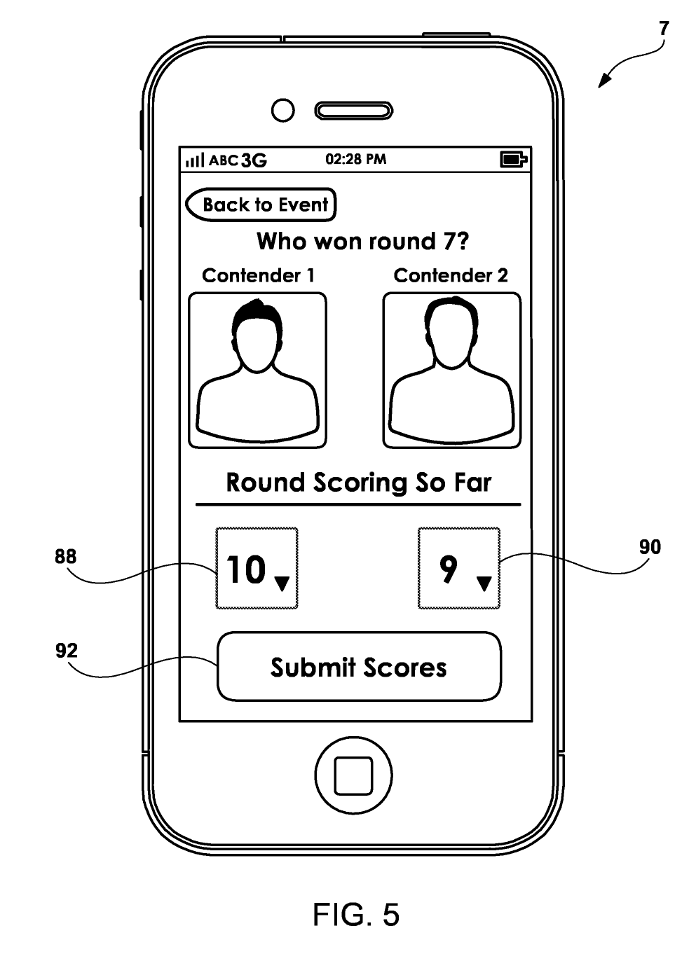

If the member has chosen the Round-by-Round scoring method then the Round-by-Round Screen as shown in FIG. 5 is displayed. While the member is watching the match, the member can score each fighter by decreasing the score using the Contender 1 Scroll Button 88 or the Contender 2 Scroll Button 90. After the round the member would click the Submit Scores Button 92 to submit the score for that round. Then the Screen would update for the next round until the end of the match.

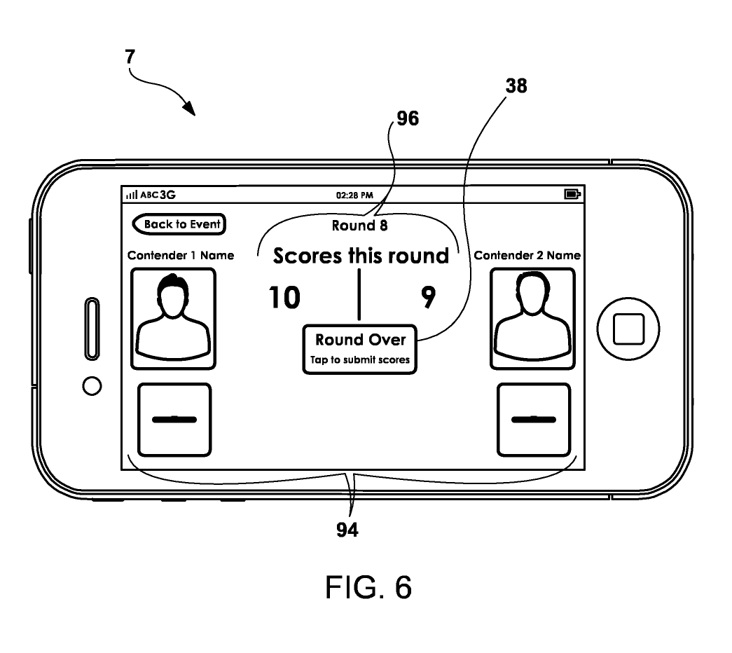

If the member has chosen the Judge Like a Pro scoring method, then the Judge Like a Pro screen as shown in FIG. 6 is displayed. During the round the member can decrease each contender's score by pressing the Minus Key 94 for appropriate contender. The scores are recorded in Score Display 96. Once the round is over, the member can submit his final score by clicking Submit Button 38.

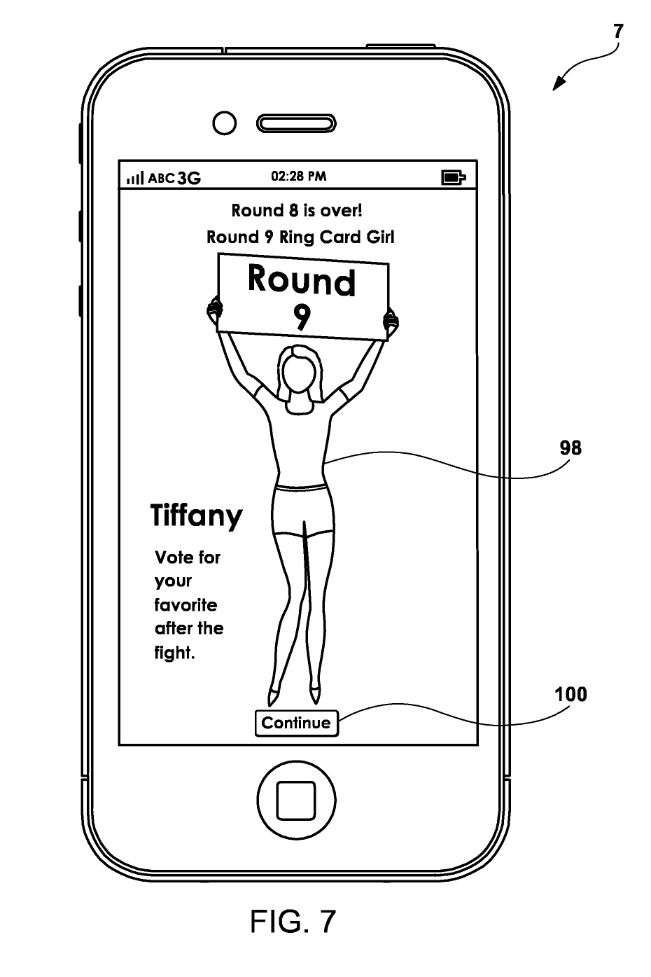

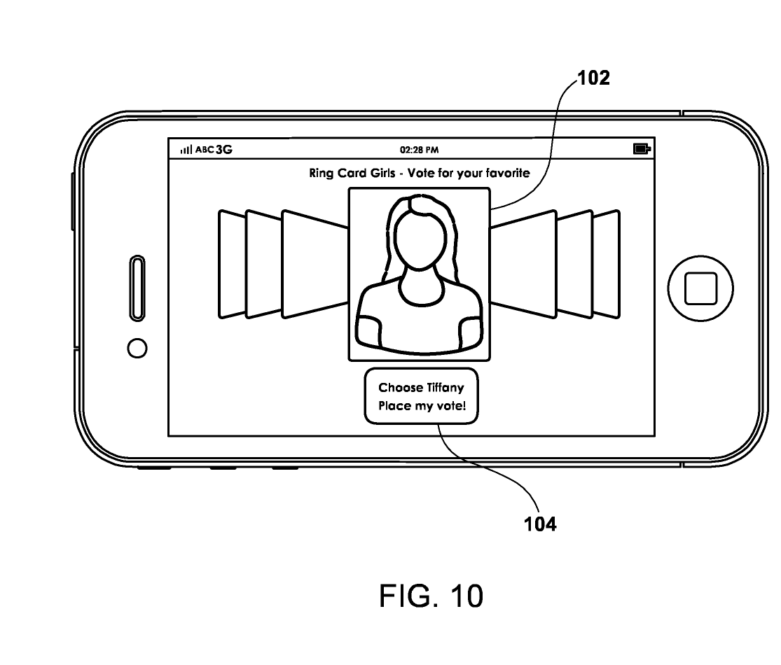

If the member has chosen either the Round-by-Round or Judge Like a Pro scoring method, then at the end of each round a Ring Card Screen as shown in FIG. 7 is displayed. The Ring Card screen will show an image of a Ring Card Model. As described herein, the Ring Card Model is a female; the Ring Card Model could be of either sex. An image or photo of a Ring Card Girl 98 holding up the round card is displayed along with the name of the Ring Card Girl 98. Various advertising material may be displayed on the round card, on the clothing of the Ring Card Girl 98 and/or as part of the background of the screen. After the member has had a chance to review this screen, the Continue Button 100 can be clicked to go back to one of the scoring method screens in order to score and vote for the next round. At the end of each round a Ring Card screen will be displayed with a different Ring Card Girl 98 shown in the screen. This cycle will be repeated until the end of the match. The member will have an option at the end of the match to vote for the Ring Card Girl 98 of his choice as shown in FIG. 10.

At the end of the match, the Vote for Ring Card Girl screen will be displayed as shown in FIG. 10. The name and photo of each of the previously displayed Ring Card Girl 102 will be able to be reviewed by scrolling though them. The member will then be able to select a particular Ring Card Girl and vote for her by clicking on the Place my Vote Button 104. At the end of a predetermined period of time, the voting will be closed and members can view the winner and the total votes that each of the Ring Card Girls received.

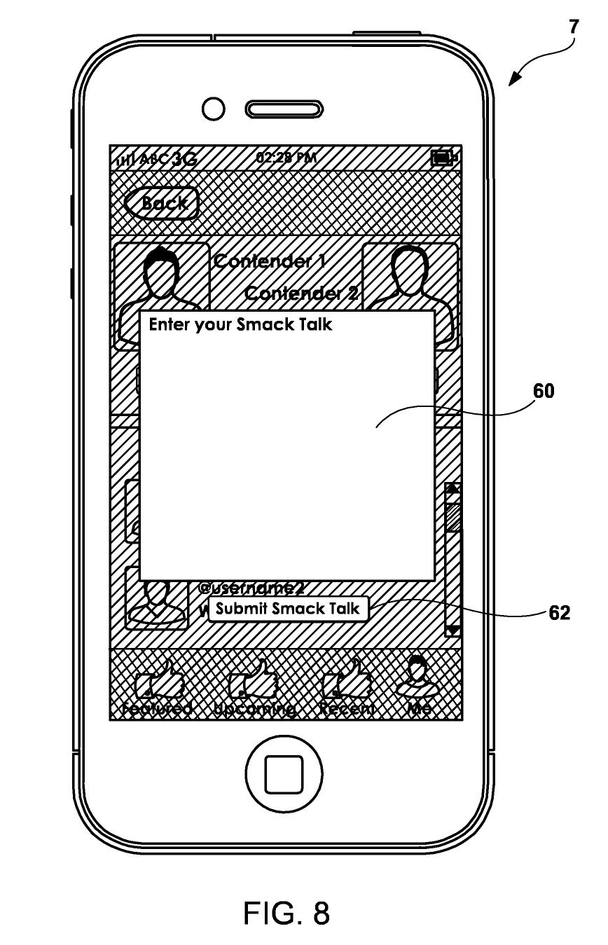

FIG. 8 shows the Enter Comment Screen. This screen is available from several of the other screens that are part of the Sport Voting System. When this screen is displayed, the member may enter a comment in the Comment Box 60. Once the comment has been entered, the member clicks on the Submit Smack Talk Button 62 and the comment will then be added to all of the other comments which can be viewed by other members and users of the System. If the member has submitted a member photo and/or social media handle that too can be displayed along with the comment. If called for the comments can be screened by System staff and not posted publically until they have been reviewed. As an alternative, the comments can be reviewed by the System software which would reject those comments which include inappropriate language.

FIG. 12 is a graphic perspective of the System of the present invention including the components the Sport Voting System. The System includes one or more Servers 80 which may also contain Database 78. Database 80 could also be stored on one or more remote storage facilities or “cloud” sites which can be utilized by more than one or more Servers 80. The Server 80 is connected to the Internet 84 and optionally includes a Firewall 82 to thwart unauthorized access to the one or more Servers 80 and Databases 78. The Internet 84 is further connected to one or more Communication Devices 70. The Communication Devices 70 may be wired or wireless so that the Communication Devices 70 can communicate with a Monitoring Apparatus 72 which can be either a mobile device such as a smart phone or tablet which would typically have WIFI capabilities, as well as wired devices that are connected via cables to routers or similar devices. Wireless communication may be via WIFI or Bluetooth protocols or other protocols currently implemented or that may be implemented in the future. A Member 74 can utilize a Monitoring Apparatus 72 to access the present invention Sport Voting System. The Server 80 tracks the date, time and details of the scheduled event and catalogs the information for processing and storage on the database 78.

### Other Scoring Methods

The scoring methods discussed above are intended for scoring a boxing match. Variations and modifications of these scoring methods can be implemented for other sports, including but not limited to baseball, football, soccer, basketball, hockey, car races, horse races, golf, boxing, mixed martial arts, skiing and snowboarding, boat racing, tennis, racquetball, motorcycle racing, rugby, cycling, swimming, cricket, and bowling.

For instance, a contested play in a baseball, football, basketball game or similar event could be voted on. In such a circumstance, the System would enable System staff to enter into the system, in near real time, the identification of a contested play (e.g. Player Smith from Team 1 called out at third base) so that members could then vote on whether the play was properly judged by the officials. System staff would make their own judgment calls about which aspects of an event were sufficiently contestable to merit entry into the voting system. A Contested Play screen would be made available to the member for the event selected. This screen would identify the event selected and have a scrolling list of Contested Plays as entered by the System staff. The member would be able to scroll though the list as it was created during the actual event or scroll through the complete list once the event was over. The member could select any Contested Play and vote whether the play was properly called by the official.

Ice skating, ice dancing, gymnastics and similar sports could be voted on by allowing the members to enter the score that they think the participant should have received.

### Registration of Members

In order to gain access to the system in order to vote, prospective members would need to register by providing some or all of the following identification information such as an e-mail address, social media identification information, a member id name, a photo of the member, a password, sex, age, sports team affiliation, geographic location and a credit card. Once the information has been validated, possible conflicts in member names resolved, credit card authenticated, then the prospective member becomes registered and the member can log in with his member id and password and vote on any of the events made available on the System. Various levels of member status can be implemented. For example, a single fee per month would allow members to vote on any event made available on the System. Alternatively, members might be charged for each specific event that the member wanted to vote on. One way to implement that would be to have the Choose a Scoring Method screen include an authorization check box which would allow the System to bill his credit card of record for the particular voting method chosen.

### Advertising

In addition to member registration fees, income can be derived by selling advertising. Advertiser's logos and other advertising material can be inserted into most any of the screens described above of or included as separate screens that would be displayed in between rounds in a boxing match, between innings in a baseball game or In addition, advertiser's logos can be included on the round cards and/or the clothing of the Ring Card Girls.

### Sponsorships

In addition to the advertising schemes discussed above, companies can become sponsors. Sponsors would typically be business operations such as sports bars, restaurants, and pool halls who have television monitors mounted within their businesses. This would enable patrons of these establishments to watch various sporting events. The company would also provide wireless internet access, typically via a router or other communication device supporting the WIFI protocol or other communication protocols, throughout the establishment.

The System would be configured to recognize the particular routers or communications devices used in the sponsor's establishments. The System would further allow any patron, whether they were a registered member of the System or not, to be able to logon and vote on the various events being shown on television monitors within the sponsor's establishment. The System, being able to recognize that the patron or member was communicating over a sponsor's communication devices, would know that the patron was located at a particular sponsor's establishment. The System would therefore replace most or all of the advertising displayed on the patron's or member's monitoring device with the sponsor's advertisements. The sponsor would have to pay a fee in order to have the sponsor's advertisements displayed on his patron's monitoring devices. This could be a monthly or annual fee or perhaps a fee based on the number of patrons or members who have utilized the System while in the sponsor's establishment.

While this invention has been described as having a preferred design, the present invention can be further modified within the spirit and scope of this disclosure. The application is therefore intended to cover any variations, uses, or adaptations of the invention using its general principles. Further, this application is intended to cover such departures from the present disclosure that arise from known or customary practice and the art to which this invention pertains and which fall within the limits of the appended claims.

What I claim is:

1. A method for recording and tabulating votes by spectators of events comprising the steps of:
a. providing one or more servers which store digital information about one or more events;
b. providing one or more monitoring devices;
c. connecting said monitoring devices to said servers via communication protocols;
d. providing server software which allows said servers to communicate to said monitoring devices information about said event;
e. providing monitor software which allows said monitoring devices to receive information from said servers about said events;
f. said monitor software is configured to allow a spectator to login to said software, select one of the events based upon information about the event which has been received from said servers, and allow the spectator to input the spectator's score of one or more aspects of the selected event into the monitor software;
g. communicating said spectator's score of the various aspects of the selected event from the monitoring devices to said servers; and
h. tabulation by said server software of all of the spectators' scores and communicating the results of said tabulation to the monitoring devices where said tabulation can be reviewed by the spectators.

2. The method of claim 1 wherein said spectator can input the evaluations only after having registered as a member and paying a fee.

3. The method of claim 2 wherein said server software, said monitoring software or a combination of the two, allows each spectator to enter only one evaluation for any one aspect of each event.

4. The method of claim 3 wherein the tabulation is not used in any manner to effect or change the official outcome of the event.

5. The method of claim 1 wherein a business establishment may pay a fee to become a sponsor.

6. The method of claim 3 wherein said spectator can select from one or more methods of scoring configured for the particular type of event.

7. The method of claim 1 wherein said monitor software, said server software or a combination of the two allows for entry into the server database information about a contested call occurring during an event which then allows for voting by the members regarding the contested call.
